(19) United States
(12) Patent Application Publication
(10) Pub. No.: US 2005/0114872 A1
(43) Pub. Date: May 26, 2005

(54) Loading mechanism for a recording/reproducing apparatus

(75) Inventor: Hong-Jen Liu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/949,477

(22) Filed: Sep. 24, 2004

(30) Foreign Application Priority Data
Nov. 22, 2003 (CN) 200310112345.8

(51) Int. Cl. G11B 5/008; G11B 17/03; G11B 17/04; G11B 33/02

(52) U.S. Cl. 720/607

(57) ABSTRACT

A loading mechanism for a recording/reproducing apparatus includes a loading motor, a pulley unit, a gear unit, a cam member, a manual ejection member, and a tray. The pulley unit includes a small pulley wheel, a large pulley wheel, and a belt connecting the small pulley wheel and the large pulley wheel. The gear unit includes a drive gear and a driven gear in mesh with each other. The driven gear includes a large gear and a pinion, the large gear being in mesh with the drive gear. The tray includes a gear rack in mesh with the pinion of driven gear of the gear unit. A hardness of the driven gear is less than hardnesses of corresponding portions of the cam member and the gear rack engaging therewith, therefore the loading mechanism operates with low noise. Furthermore, the two-grade speed reduction configuration requires relatively few components.

### BACKGROUND OF THE INVENTION

1. Field of the Invention

The present invention generally relates to a loading mechanism for a recording/reproducing apparatus such as an optical disc drive, and more particularly to a loading mechanism providing stable and quiet loading of a disc.

2. Description of the Related Art

One of the most important parts of a disc drive is its loading mechanism, which is used to control the loading and unloading of discs. A conventional loading mechanism comprises several gear groups adapted to transmit mechanical power and reduce the speed of transmission of the power. Sony Corporation's model KSL-213 disc drive is a typical example.

A schematic representation of the loading mechanism of the KSL-213 model is shown in FIG. 5. A driven gear 1a is driven by a tray motor. A first grade speed-down gear 2a is in mesh with the driven gear 1a. A second grade speed-down gear 3a is in mesh with the first grade speed-down gear 2a. A third grade speed-down gear 4a is in mesh with the second grade speed-down gear 3a . The third grade speed-down gear 4a is also in mesh with a gear rack of a tray 5a, so that the tray 5a slides in or out and thereby loads or ejects a disc.

However, the various gear groups make the loading mechanism an unduly complex structure. In addition, the tray and most of the gears are made of ABS (Acrylonitrile Butadiene Styrene), or another kind of plastic material with high hardness. When these rigid gears operate in mesh with each other, they are liable to generate excessive noise.

### SUMMARY OF THE INVENTION

Accordingly, an object of the present invention is to provide a stable loading mechanism for a disc drive which operates with relatively low noise.

Another object of the invention is to provide a loading mechanism for a disc drive which has relatively few components.

In order to achieve the objects set out above, a loading mechanism for a recording/reproducing apparatus of the present invention comprises a loading motor, a pulley unit for power transmission and speed reduction, a gear unit for further speed reduction, a slidable cam member engagable with the driven gear of the gear unit for raising and lowering a sub-chassis, a manual ejection member for manual unloading, and a tray for loading a disc thereon. The pulley unit comprises a small pulley wheel, a large pulley wheel, and a belt connecting the small pulley wheel and the large pulley wheel. The gear unit comprises a drive gear and a driven gear in mesh with each other. The driven gear comprises a large gear and a pinion, the large gear being in mesh with the drive gear. The tray comprises a gear rack formed on an inner lateral side thereof, the gear rack being in mesh with the pinion of the driven gear of the gear unit. A hardness of the driven gear is less than hardnesses of corresponding portions of the cam member and the gear rack engaging therewith, therefore the loading mechanism operates with low noise. Furthermore, the large pulley wheel and the drive gear are formed together, and the pinion and the large gear are formed together. Therefore, the loading mechanism has relatively few components and low production costs.

Other objects, advantages and novel features of the present invention will become more apparent from the following detailed description when taken in conjunction with the accompanying drawings, in which:

### BRIEF DESCRIPTION OF THE DRAWINGS

FIG. 1 is an isometric view of a loading mechanism in accordance with the present invention mounted on a main chassis of a disc drive, but not showing a tray of the loading mechanism;

FIG. 2 is similar to FIG. 1, but viewed from a rear aspect;

FIG. 3 is an enlarged, inverted view of a speed-down gear and a driven wheel of the loading mechanism shown in FIG. 2, the speed-down gear and the driven wheel being in mesh with each other;

FIG. 4 is isometric, inverted view of the tray of the loading mechanism in accordance with the present invention; and

FIG. 5 is a bottom plan view of a conventional loading mechanism for a disc drive.

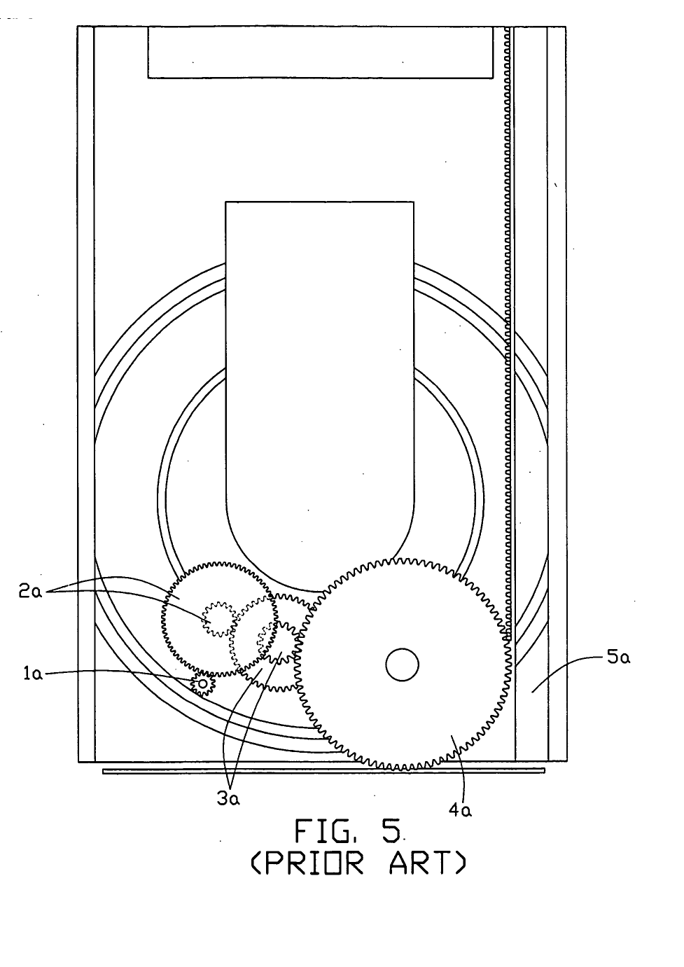

### DETAILED DESCRIPTION OF THE INVENTION

Reference will now be made to the drawing figures to describe the preferred embodiment of the present invention in detail.

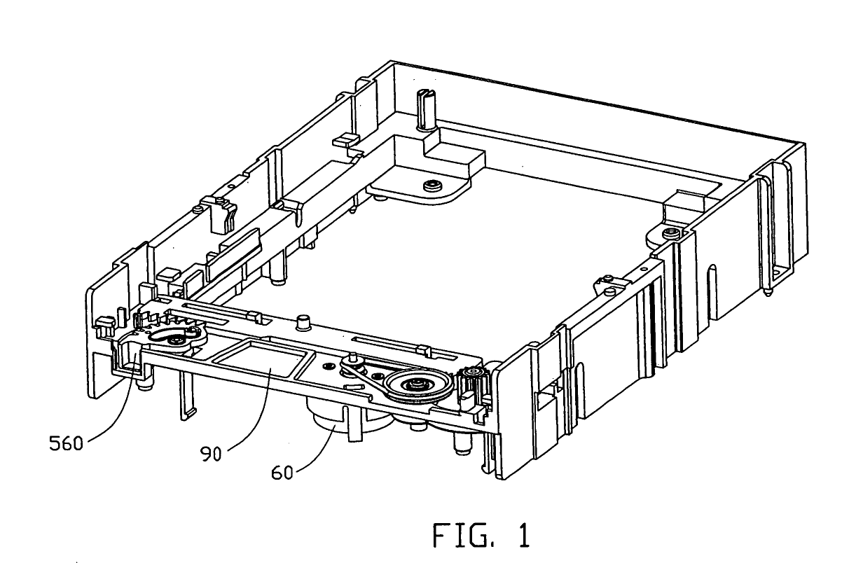

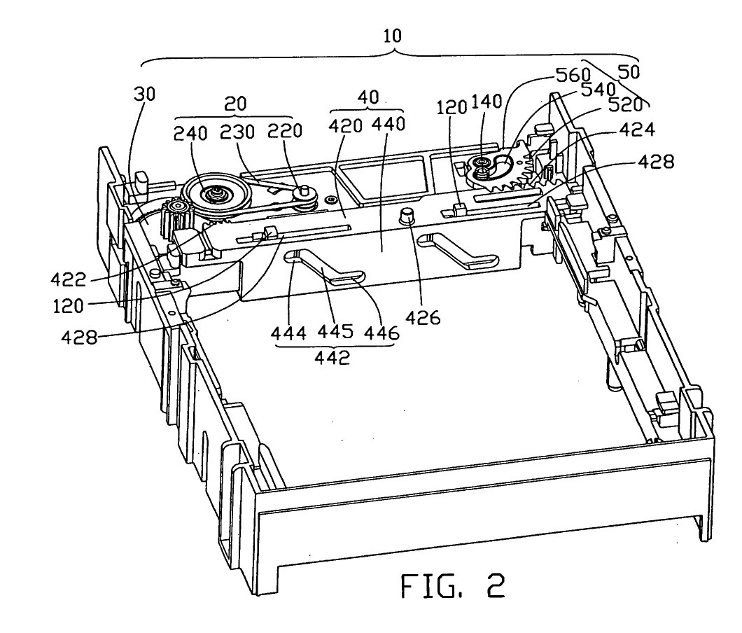

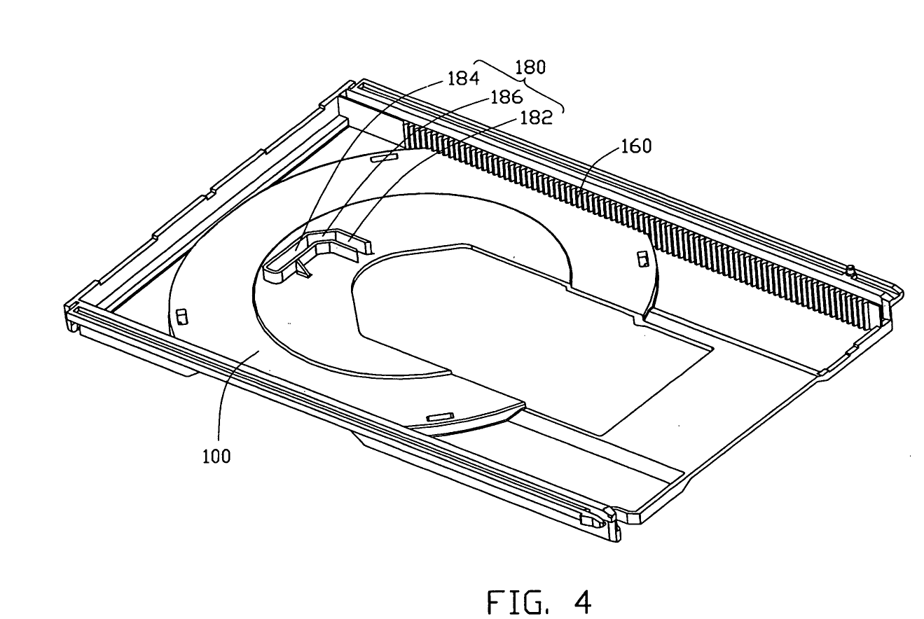

As shown in FIGS. 1 and 2, a loading mechanism 10 of the present invention is fixed on a front beam of a main chassis 90 of a disc drive. The loading mechanism 10 is adapted to control a tray 100 (see FIG. 4) that moves into and out of the disc drive, and to lift up a sub-chassis (not shown) for clamping a loaded disc. The loading mechanism 10 comprises a pulley unit 20, a speed-down gear unit 30, a cam slider 40, a manual ejection gear 50, and a loading motor 60. Both of the cam slider 40 and tray 100 perform as motor-power-consumption components.

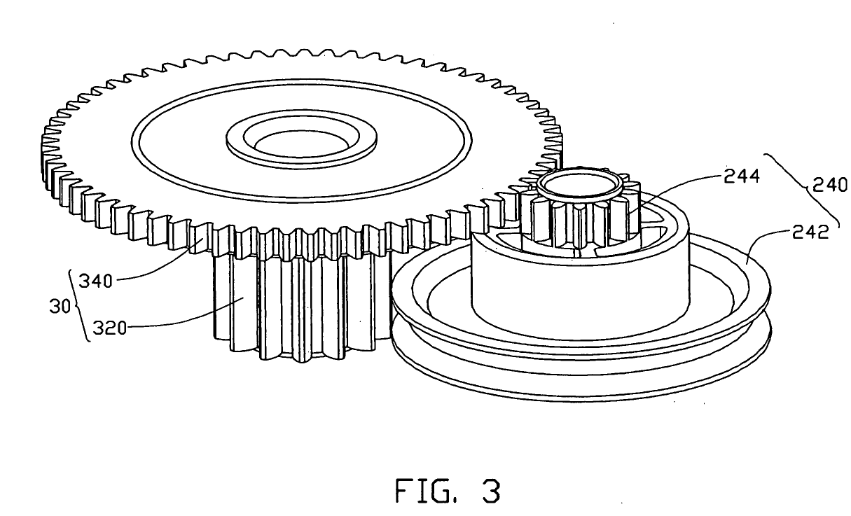

The pulley unit 20 comprises a drive wheel 220 mounted on a spindle of the loading motor 60, a belt 230, and a driven wheel 240. Referring also to FIG. 3, the driven wheel 240 comprises a belt pulley 242 with a larger radius than the drive wheel 220, and a pinion 244 integrally formed with the belt pulley 242. The belt 230 is retained in a pulley groove of the drive wheel 220 and a pulley groove of the belt pulley 242 of the driven wheel 240, for power transmission and speed reduction.

The speed-down gear unit 30 is made of a polyester elastomer (such as Hytrel-5526 or the like), and comprises a pinion 320 and a bull gear 340. The bull gear 340 is in mesh with the pinion 244 of the driven wheel 240 for further speed reduction.

The cam slider 40 is slidably mounted on a rear of the front beam of the main chassis 90. The cam slider 40 comprises a horizontal portion 420 and a vertical portion 440. The horizontal portion 420 comprises a first rack 422, a second rack 424, a columnar protrusion 426, and two aligned sliding grooves 428. The first and second racks 422, 424 are respectively formed at two distal ends of the horizontal portion 420. The first rack 422 can mesh with the pinion 320 of the speed-down gear unit 30. The columnar protrusion 426 is upwardly formed between the sliding grooves 428. The sliding grooves 428 respectively slidably receive two claws 120 of the front beam. The vertical portion 440 defines two parallel generally Z-shaped slots 442. Each Z-shaped slot comprises an upper horizontal portion 444, a slant portion 445, and a lower horizontal portion 446. Two guide pins of the sub-chassis are respectively movably received in the Z-shaped slots 442, to raise and lower the sub-chassis for clamping the disc.

The manual ejection gear 50 comprises an arcuate rack portion 520, an arcuate restriction groove 540, and a push portion 560. The rack portion 520 is in mesh with the second rack 424 of the cam slider 40. A stop pin 140 is movably received in the arcuate restriction groove 540. The rack portion 520 and the restriction groove 540 subtend a common center point of their respective arcs.

Now referring to FIG. 4, the tray 100 is made of ABS (Acrylonitrile-Butadiene-Styrene), or a composition of ABS and another plastic material (such as polycarbonate). The tray 100 comprises a gear rack 160 and a generally L-shaped guiding path 180. The gear rack 160 is provided on one inner lateral side of the tray 100, and spans almost an entire length of the tray 100. The guiding path 180 comprises a longitudinal section 182, a traverse section 184, and an oblique section 186 interconnecting the longitudinal and traverse sections 182, 184. The guiding path 180 slidably receives the protrusion 426 of the cam slider 40 therein, for locking the tray 100 in position.

When loading a disc into the disc drive, power is supplied to the loading motor 60, and the drive wheel 220 rotates clockwise along with the spindle of the loading motor 60. The driven wheel 240 is thus driven via the belt 230 at a certain transmission ratio. Simultaneously, the speed-down gear unit 30 is driven anti-clockwise via the meshed gears of the pinion 244 and the bull gear 340. With the speed-down gear unit 30 rotating anti-clockwise, because the speed-down gear unit 30 is in mesh with the gear rack 160 of the tray 100, the tray 100 having the disc loaded thereon slides inward. The speed-down gear unit 30 then meshes with the cam slider 40, so that the cam slider 40 slides leftward to raise the sub-chassis for clamping the disc.

Conversely, when unloaded the disc from the disc drive, power is supplied to the loading motor 60, and the drive wheel 220 rotates anti-clockwise along with the spindle of the loading motor 60. The speed-down gear unit 30 rotates clockwise, the cam slider slides 40 slides rightward to lower the sub-chassis for releasing the disc, and the tray 100 slides outward. Further, in case of failure, a user can push the push portion 560 of the manual ejection gear 50 to slide the cam slider 40 rightward, and thereby still be able to unload the disc. Failure may occur, for example, when the belt 230 breaks or is displaced, or when the power supply is suddenly cut off.

Because the speed-down gear unit 30 is made of a polyester elastomer, it is softer than the first rack 422 and the gear rack 160 that it meshes with. Little noise among the engaged parts is produced, and the mechanical transmission is more stable. Furthermore, the loading mechanism 10 adopts only a two-grade speed reduction, and therefore requires relatively few components. The pulley unit 20 contributes to steady operation of the whole power-transmission system and easy installation of all components including the loading motor 60, gear unit 30 and cam slider 40.

In alternative embodiments, the speed-down gear unit 30 can be made of another kind of plastic material which is softer than the other components engaged therewith.

Although the present invention has been described with reference to specific embodiments, it should be noted that the described embodiments are not necessarily exclusive, and that various changes and modifications may be made to the described embodiments without departing from the scope of the invention as defined by the appended claims.

1. A loading mechanism for a recording/reproducing apparatus, comprising:
a loading motor for driving the loading mechanism;
a pulley unit for power transmission and speed reduction, including a small pulley wheel, a large pulley wheel, and a belt connecting the small pulley wheel and the large pulley wheel;
a gear unit for further speed reduction, including a drive gear and a driven gear in mesh with each other;
a cam member engagable with the driven gear of the gear unit, the cam member being adapted to be connected to a main chassis of the recording/reproducing apparatus for raising and lowering of a sub-chassis of the recording/reproducing apparatus;
a manual ejection member for manual unloading, the manual ejection member being in mesh with the cam member; and
a tray for loading a disc thereon, the tray including a gear rack engaged with the driven gear of the gear unit;
wherein a hardness of a portion of the driven gear is lower than hardnesses of corresponding portions of the cam member and the gear rack engaging therewith.

2. The loading mechanism as recited in claim 1, wherein the driven gear of the gear unit comprises a pinion and a large gear rotatable in unison.

3. The loading mechanism as recited in claim 2, wherein the large pulley wheel and the drive gear are rotatable in unison.

4. The loading mechanism as recited in claim 3, wherein the small pulley wheel is provided on a spindle of the loading motor.

5. The loading mechanism as recited in claim 4, wherein the large gear of the driven gear has a diameter greater than a diameter of the drive gear, and the large gear is in mesh with the drive gear.

6. The loading mechanism as recited in claim 5, wherein the pinion of the driven gear meshes with both the cam member and the gear rack of the tray.

7. The loading mechanism as recited in claim 6, wherein the cam member comprises a horizontal portion and a vertical portion, and the horizontal portion comprises a first rack and a second rack respectively at two distal ends thereof.

8. The loading mechanism as recited in claim 7, wherein the manual ejection member comprises an arcuate rack portion, an arcuate restriction groove, and a push portion.

9. The loading mechanism as recited in claim 8, wherein the first rack meshes with the pinion of the driven gear, and the second rack is in mesh with the rack portion of the manual ejection gear.

10. The loading mechanism as recited in claim 7, wherein the vertical portion of the cam member defines a pair of parallel generally Z-shaped slots, each of the slots comprising an upper horizontal portion, a slant portion, and a lower horizontal portion.

11. The loading mechanism as recited in claim 10, wherein the Z-shaped slots are adapted to slidingly receive a pair of guide pins of the sub-chassis.

12. The loading mechanism as recited in claim 11, wherein the tray further comprises a generally L-shaped guiding path for locking and unlocking thereof, and the gear rack is provided on one inner side of the tray.

13. The loading mechanism as recited in claim 12, wherein the tray is made of Acrylonitrile-Butadiene-Styrene, and the driven gear is made of a polyester elastomer.

14. A recording/reproducing apparatus, comprising:
a main chassis for mounting a plurality of components of the recording/reproducing apparatus thereon;
a loading motor for driving a loading mechanism;
a first transmission unit for power transmission and speed reduction, including a first drive member and a first driven member;
a second transmission unit for power transmission and further speed reduction, including a second drive member and a second driven member;
a tray for loading a disc thereon, the tray being engaged with the second driven member of the second transmission unit;
a cam member engagable with the second driven member of the second transmission unit and connected to the main chassis, for raising and lowering a sub-chassis of the recording/reproducing apparatus; and
a manual ejection gear engaged with the cam member, for manually ejecting the tray;
wherein a hardness of a portion of the second driven member is lower than
hardnesses of corresponding portions of the cam member and the tray engaging
therewith.

15. The recording/reproducing apparatus as recited in claim 14, wherein the tray is made of Acrylonitrile-Butadiene-Styrene, and the second driven member is made of a polyester elastomer.

16. The recording/reproducing apparatus as recited in claim 15, wherein the first transmission unit is a pulley unit comprising two pulleys.

17. The recording/reproducing apparatus as recited in claim 15, wherein the second transmission unit is a gear unit, the second drive member comprising a smaller drive gear, and the second driven member comprising a larger driven gear in mesh with the smaller drive gear.

18. The recording/reproducing apparatus as recited in claim 17, wherein the second driven member further comprises a pinion rotating in unison with the larger driven gear, the pinion meshing with both the cam member and the tray.

19. A recording/reproducing apparatus, comprising:
a main chassis;
a loading motor installed in said main chassis;
a pulley unit installed in said main chassis next to said loading motor, and comprising a drive wheel connected to said loading motor for power transmission from said loading motor, a driven wheel spaced away from said loading motor and connected to said drive wheel by a belt for power transmission from said drive wheel, and a pinion coupling with said driven wheel to move therewith;
a gear unit engaging with said pinion for power transmission from said pinion; and
at least one power-consumption component installed in said main chassis and comprising a portion engaging with said gear unit to perform a predetermined function thereof by means of transmitted power from said gear unit.

20. The recording/reproducing apparatus as recited in claim 19, wherein said gear unit is made of material softer than one of said pinion and said portion of said at least one power-consumption component.
